(19) United States
(12) Patent Application Publication
(10) Pub. No.: US 2010/0068565 A1
(43) Pub. Date: Mar. 18, 2010

(54) VARIABLE FUEL PRESSURE CONTROL FOR A FUEL CELL

(76) Inventors: Venkateshwarlu Yadha, Manchester, CT (US); Matthew P. Wilson, Groton, CT (US); Praveen Narasimhamurthy, Vernon, CT (US)

Correspondence Address: CARLSON, GASKEY & OLDS, P.C., 400 WEST MAPLE ROAD, SUITE 350, BIRMINGHAM, MI, 48009, US

(21) Appl. No.: 12/447,343

(22) PCT Filed: Dec. 19, 2006
(86) PCT No.: PCT/US06/48331

§ 371 Date: Apr. 27, 2009

(51) Int. Cl. H01M 8/00; H01M 2/02; H01M 8/04

(52) U.S. Cl. 429/13; 429/34; 429/25

(57) ABSTRACT

A fuel cell includes a cathode having an air flow field. An anode includes an inlet and an outlet for providing unused fuel to a fuel recycling line. A pressure regulator is arranged upstream from an ejector and communicates with the air flow field for adjusting a fuel pressure at the motive inlet in response to an air pressure associated with the air flow field. The cathode and/or anode includes a porous water transport plate adjacent to the air flow field and/or fuel flow field respectively. A back pressure valve is arranged downstream from the air flow field for producing an air back pressure that generates a desired differential pressure across the water transport plate. The back pressure valve is controlled to achieve the desired differential pressure across the water transport plate so that the fuel cell maintains water balance.

### BACKGROUND

This application relates to a fuel cell, and more particularly, the invention relates to a method and apparatus for regulating a fuel pressure provided to a fuel cell anode. The application also relates to maintaining a desired differential pressure across a water transport plate within the fuel cell.

Fuel cells include a cathode and an anode that cooperate with an electrode assembly to produce electricity resulting from an electrochemical process. The anode receives hydrogen, and the cathode receives air. The hydrogen and air react during the electrochemical process to produce electricity. Water transport plates are used in some fuel cells to manage water in a water flow field adjoining the cathode and/or anode. Maintaining water balance better ensures fuel cell operational efficiency.

The consumption of hydrogen within the fuel cell must be managed to achieve industry requirements for fuel efficiency. Fuel pressure fluctuates during fuel cell operation making fuel consumption difficult to manage. In one example effort to achieve fuel efficiency, fuel cells have been developed that employ a recirculation loop that returns unused fuel from the anode to the anode's inlet. Some recirculation loops have employed blowers to ensure an adequate supply of fuel to the inlet.

It is desirable that the fuel pressure supplied to the anode generally track the air pressure supplied to the cathode, in particular during transient conditions, so that adequate fuel is supplied to the anode to achieve the most efficient production of electricity. Fuel cells incorporating a recirculation loop with a blower have not employed features that ensure the fuel pressure provided to the inlet increases and decreases with increasing and decreasing air consumption by the cathode.

An ejector has been used to regulate the fuel pressure provided to the anode. The fuel from the recirculation loop is provided to a suction inlet of the ejector. A sense line downstream from the ejector communicates with a dome pressure regulator upstream from the ejector to ensure that a desired fuel pressure is achieved by the ejector at the anode inlet.

Some arrangements utilizing an ejector to provide fuel to the anode also include a line that communicates the cathode air pressure to the dome pressure regulator, which ensures that the fuel pressure more closely tracks the air pressure. However, prior art arrangements do not address regulating the pressure within the air and fuel flow fields to maintain a desired differential pressure across the water transport plates, which is necessary for water balance within the fuel cell. Having too great of a pressure within a flow field may force water out of the water transport plate and into the water flow field, which may dry out the associated anode and/or cathode. Having too little pressure in the flow field may flood the anode and/or cathode with water from the water flow field. This is particularly true for cooling systems in which a pump is used to circulate the water in the flow field for cooling. The pump may increase the water flow field pressure and undesirably reduce the differential pressure across the water transport plate making it difficult to maintain water balance.

What is needed is a fuel cell that recirculates unused fuel while maintaining a desired fuel pressure relative to the air pressure and while achieving a desired differential pressure across the water transport plate.

### SUMMARY

A fuel cell includes a cathode having an air flow field. An anode includes an inlet and an outlet for providing unused fuel to a fuel recycling line in one example. In one example embodiment, an ejector includes a suction inlet, a motive inlet for receiving fuel and a discharge outlet for providing a desired amount of fuel to the inlet. A blower is in communication with the recycling line for providing unused fuel to the suction inlet to achieve the desired amount of fuel. A pressure regulator is arranged upstream from the ejector and communicates with the air flow field for adjusting a fuel pressure at the motive inlet in response to an air pressure associated with the air flow field. Providing air pressure feedback to the pressure regulator enables the fuel pressure to better track the air pressure during fuel cell operation.

The cathode and/or anode includes a porous water transport plate associated with the air flow field and/or fuel flow field respectively. A back pressure valve is arranged downstream from the air flow field for producing an air back pressure that generates a desired differential pressure across the water transport plate. The back pressure valve is controlled to achieve the desired differential pressure across the water transport plate so that the fuel cell maintains water balance.

These and other features of the application can be best understood from the following specification and drawings, the following of which is a brief description.

### BRIEF DESCRIPTION OF THE DRAWINGS

FIG. 1 is a schematic view of a fuel cell including a fuel recirculation loop, a cooling loop and a control system.

### DETAILED DESCRIPTION OF THE PREFERRED EMBODIMENT

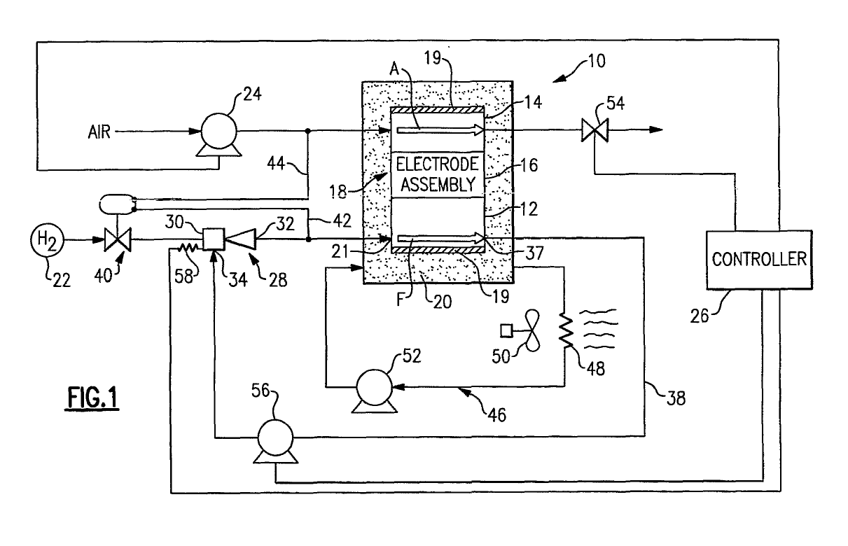

A fuel cell 10 is schematically shown in FIG. 1. The fuel cell 10 includes an anode 12 and a cathode 14 arranged on either side of an electrode assembly 16. The anode, cathode and electrode assembly 12, 14, 16 provide a cell 18. Typically multiple cells are arranged in a stack to produce a desired amount of electricity.

In one example, the anode 12 and cathode 14 include a water transport plate 19 that is in communication with a water flow field 20. The water flow field 20 hydrates the water transport plates 19 and receives product water from the cell 18 resulting from the electrochemical reaction within the cell. In the example, the water transport plate 19 is porous. One or both of the cathode and anode, 14, 12 may include the porous water transport plate 19. The water transport plate 19 typically requires a desired differential pressure across it to achieve desired water balance during fuel cell operation so that the water transport plates 19 are hydrated but do not flood the air or fuel flow fields. The water transport plates 19 also provide a wet seal between the anode 12 and cathode 14 to prevent undesired commingling of the hydrogen and air.

The anode 12 includes a fuel flow field F receiving hydrogen from a fuel source 22. The cathode 14 includes an air flow field A receiving an oxidant, such as air, provided by a pump 24. A controller 26 controls the operation of the pump 24 to provide a desired amount of air to the fuel cell 10 based upon its operational needs.

The anode 12 includes an inlet 21 and an outlet 37. An ejector 28 is arranged between the fuel source 22 and the inlet 21 to provide fuel to the anode 12. The ejector 28 includes a motive inlet 30 that receives fuel from the fuel source 22. A discharge outlet 32 provides fuel from the ejector 28 to the anode 12. A fuel recycling line 38 circulates unused fuel from the outlet 37 to a suction inlet 34 of the ejector 28. In the example shown, a blower 56 is used to return the unused fuel from the anode 12 is returned to it under conditions in which the ejector 28 is inefficient. The controller 26 communicates with the blower 56 to regulate its operation based upon fuel cell characteristics.

A dome pressure regulator 40 is arranged upstream from the ejector 28 to regulate the fuel pressure provided to the anode 12. A sense line 42 communicates with the fuel supply from a location downstream from the ejector 28 to the dome pressure regulator 40 to provide feedback to the dome pressure regulator 40, which ensures that a desired amount of fuel is being provided by the ejector 28. In one example, the sense line 42 fluidly communicates the pressure downstream from the ejector 28 to the dome pressure regulator 40.

A cathode inlet pressure line 44 is in communication with the air flow field A and the dome pressure regulator 40. The cathode inlet pressure line 44 regulates the fuel pressure to the motive inlet 30 to ensure that the fuel pressure provided to the anode 12 from the discharge outlet 32 remains above the air pressure in the cathode 14, in one example embodiment. The input provided from the cathode inlet pressure line 44 to the dome pressure regulator 40 also ensures that the fuel pressure tracks the air pressure, in particular during transients. That is, the input from the cathode inlet pressure line 44 ensures fuel pressure increases and decreases as the air pressure increases and decreases, respectively. In one example, the difference between the fuel and air pressures remains the same throughout operation of the fuel cell 10.

A cooling loop 46 is in communication with water from the water flow field 20. Water that has received heat from the cells stack (for example, due to the electrochemical process) is circulated to a heat exchanger 48 (for example a condenser). Heat is removed from the water at the heat exchanger 48 via a working fluid such as air circulating through the heat exchanger 48 using a fan 50. In the example, a coolant pump 52 is used to circulate the water within the cooling loop 46. The coolant pump 52 typically produces a pressure within the water flow field 20 that affects the differential pressure across the wet seal in the water transport plate 19. The cooled water is circulated back to the water flow field 20.

It is desirable to regulate the differential pressure across the wet seal of the water transport plate 19 to ensure that the wet seal remains integral to prevent reactant gas crossover. Additionally, the differential pressure should be maintained in order to maintain water balance. That is, the differential pressure across the water transport plate 19 should not result in flooding or dry-out of the anode and/or cathode 12, 14. To this end, a back pressure valve 54 is arranged downstream from the air flow field A to regulate the air pressure. The back pressure valve 54 communicates with the controller 26, which may monitor various pressures within the fuel cell 10 (not shown), to obtain the desired back pressure. Example pressures that are monitored include atmospheric, fuel, air and coolant pressures.

In one example, increasing the back pressure on the air flow field A increases the air pressure within the cathode 14. This may be particularly desirable in situations in which the coolant pump 52 produces a pressure within the water flow field 20 that would result in an undesired flooding of the cathode 14. Since the fuel pressure tracks the air pressure as a result of the cathode inlet pressure line 44 communicating with the dome pressure regulator 40, the fuel pressure is also increased as a result of an increase in back pressure by the back pressure valve 54. As a result, flooding of the anode is also avoided. Conversely, a reduction in back pressure using the back pressure valve 54 would result in a drop in pressure in both the anode and cathode 12, 14, which can be used to increase the hydration of the water transport plate 19.

A heater 58 can be arranged proximate to the ejector 28 to avoid undesired icing of the ejector 28 during cold weather operation of the fuel cell 10. Operation of the heater 58 is regulated by the controller in the example.

Although a preferred embodiment has been disclosed, a worker of ordinary skill in this art would recognize that certain modifications would come within the scope of the claims. For that reason, the following claims should be studied to determine their true scope and content.

1. A fuel cell comprising:
a cathode having an oxidant flow field;
a water transport plate adjacent to at least one of the oxidant flow field and a fuel flow field;
a back pressure valve downstream from the oxidant flow field for producing an oxidant back pressure that generates a desired differential pressure across the water transport plate: and
an ejector arranged upstream from the fuel flow field and including a motive inlet, the hack pressure valve controlling a fuel pressure at the motive inlet.

2. The fuel cell according to claim 1, wherein the water transport plate is porous.

3. The fuel cell according to claim 2, wherein the desired differential pressure maintains a desired water balance within the fuel cell.

4. The fuel cell according to claim 1, comprising a pressure regulator arranged upstream from the ejector, the pressure regulator increasing and decreasing the fuel pressure in response to an increase and decrease in air pressure, respectively.

5. A method of controlling water balance within a fuel cell comprising the steps of:
providing a water transport plate adjacent to at least one of an air flow field and a fuel flow field;
regulating an air back pressure downstream from the air flow field;
regulating a fuel pressure based upon an air flow field inlet pressure and a recirculated unused fuel pressure; and
maintaining a wet seal using a desired differential pressure across the water transport plate based upon the regulated pressures.

6. The method according to claim 5, comprising the step of regulating a fuel pressure to the fuel flow field with the air back pressure.

7. The method according to claim 6, wherein the fuel pressure is regulated based upon a differential pressure between the air and fuel flow fields.

8. The method according to claim 7, including maintaining the fuel pressure above the air pressure.

9. The method of claim 5, comprising the step of providing a desired amount of fuel to the anode including the step of pumping the unused fuel.

10. A fuel cell comprising:
a cathode having a cathode inlet coupled to a cathode reactant flow field coupled to a cathode outlet;
a cathode reactant backpressure valve coupled to said cathode outlet, wherein a cathode reactant flows from an oxidant source through said cathode inlet into said cathode reactant flow field into said cathode outlet through said cathode reactant backpressure valve;
an anode having an anode inlet coupled to an anode reactant flow field coupled to an anode outlet;
a water transport plate adjacent at least one of said cathode reactant flow field and said anode reactant flow field, said water transport plate configured to maintain a wet seal; and
a fuel flow control valve coupled downstream of a source of fuel and upstream of said anode inlet, said fuel flow control valve operatively coupled to said cathode reactant, said fuel flow control valve operatively coupled to said fuel supply, said fuel flow control valve and said cathode reactant backpressure valve configured to maintain said wet seal between said oxidant and said fuel across said water transport plate.

11. The fuel cell of claim 10, comprising:
a fuel recycle line coupled between said anode outlet and said anode inlet; and
a recycle pump coupled in said fuel recycle line, wherein said recycle pump is configured to recycle anode exhaust from said anode outlet to said anode inlet.
